(19) United States
(12) Patent Application Publication
(10) Pub. No.: US 2022/0356065 A1
(43) Pub. Date: Nov. 10, 2022

(54) SURFACE MODIFIED SILANIZED COLLOIDAL SILICA PARTICLES

(71) Applicant: Rohm and Haas Electronic Materials CMP Holdings, Inc., Newark, DE (US)

(72) Inventors: Changzai Chi, Hockessin, DE (US); Murali Ganth Theivanayagam, Newark, DE (US); Kwadwo Tettey, Bear, DE (US)

(21) Appl. No.: 17/697,735

(22) Filed: Mar. 17, 2022

Related U.S. Application Data
(60) Provisional application No. 63/178,061, filed on Apr. 22, 2021.

(51) Int. Cl. C01B 33/142; C09K 3/14; C01B 33/146

(52) U.S. Cl. CPC C01B 33/142; C09K 3/1472; C01B 33/146

(57) ABSTRACT

Modified silanized colloidal silica particles are reaction products of silanized colloidal silica particles having epoxy moieties with a nitrogen of an amino group of an amino acid to form stable modified silanized colloidal silica particles. The modified silanized colloidal silica particles can be used as an abrasive in chemical mechanical polishing of various substrates.

### FIELD OF THE INVENTION

The present invention is directed to surface modified silanized colloidal silica particles. More specifically, the present invention is directed to surface modified silanized colloidal silica particles which are reaction products of epoxy moieties of silanized colloidal silica particles with a nitrogen of an amino group of an amino acid to provide surface modified silanized colloidal silica particles which are stable from neutral to alkaline pH and can be used for the chemical mechanical polishing of substrates.

### BACKGROUND OF THE INVENTION

In aqueous solutions, surfaces of silica particles are covered with silanol groups and the isoelectric point of unmodified silica is at pH=2. At a high pH of 10 and above, silica particles are highly negatively charged, and dispersions are stabilized by the charge repulsion between particles. As pH drops, the dispersion becomes less stable due to the reduced surface charge. For unmodified colloidal silica, it is most unstable in the pH range of 5.0-8.5. In addition, the presence of an electrolyte in the dispersion in many applications reduces electrostatic repulsion between particles and colloidal stability and reduces stability. For many applications, including chemical mechanical polishing (CMP) slurries, it is highly desirable to improve the stability of silica particle in formulations when pH is 8.5 or below.

Silane modifications have been widely used to alter surface properties of colloidal silica particles and improve stability under various conditions. Two commonly used types of silanes are epoxysilanes and aminosilanes. U.S. Pat. No. 7,544,726 discloses a method of producing aqueous silanized colloidal silica particle dispersions with epoxysilanes. Such epoxy groups may eventually be hydrolyzed into diols providing sterically stabilized colloidal silica particles. Sterically stabilized colloidal silica particles are less sensitive to electrolytes than electrostatically stabilized colloids. However, the epoxysilane modified particles may become unstable when the pH starts to drop.

Another approach to stabilize colloidal silica particles at neutral to acidic pH is to modify the particle with cationic moieties to make particles positively charged, such as those disclosed by U.S. Pat. No. 9,028,572. However, this approach only works best when pH is below 7. A further approach to improve the stability of colloidal silica particles at neutral to mild alkaline pH is to use sulfonic acid functionalization derived from silane with thiol functional group, such as Fuso PL-2L-D colloidal silica particles. However, this approach introduces a small amount of sulfur which could be undesirable for some CMP applications.

Accordingly, there is a need for colloidal silica particles having improved stability from neutral to alkaline pH and improved chemical mechanical polishing of substrates.

### SUMMARY OF THE INVENTION

The present invention is directed to a silanized colloidal silica particle comprising a reaction product of an epoxy functionality of the silanized colloidal silica particle with a nitrogen of an amino group of an amino acid.

The present invention is also directed to a silanized colloidal silica particle having the structure:

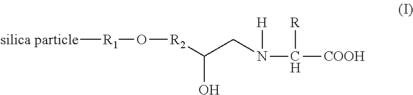

wherein R₁ and R₂ are independently chosen from linear or branched C₁-C₅ alkylene, and R is a moiety selected from the group consisting of CH₃—, NH₂—C(O)—CH₂—, NH₂—C(O)—(CH₂)₂—, guanidyl, H₂N—CH₂—, ⁺H₃N—(CH₂)₄—, HO—CH₂—, HS—CH₂—, CH₃—S—(CH₂)₂—, carboxy(C₁-C₂)alkyl, benzyl and hydroxybenzyl.

The present invention is further directed to a chemical mechanical polishing composition comprising a silanized colloidal silica particle comprising a reaction product of an epoxy functionality of the silanized colloidal silica particle with a nitrogen of an amino group of an amino acid;

water;
optionally an oxidizing agent;
optionally a complexing agent;
optionally a source of iron (III) ions;
optionally a corrosion inhibitor;
optionally a surfactant;
optionally a defoaming agent;
optionally biocide; and
optionally a pH adjustor.

The present invention is additionally directed to a chemical mechanical polishing method comprising: providing a substrate comprising a metal or a dielectric or combination of a metal and a dielectric; providing a chemical mechanical polishing composition comprising a silanized colloidal silica particle, wherein the silanized colloidal silica particle comprises a reaction product of an epoxy functionality of the silanized colloidal silica particle with a nitrogen of an amino group of an amino acid;

water;
optionally an oxidizing agent;
optionally a complexing agent;
optionally a source of iron (III) ions;
optionally a corrosion inhibitor;
optionally a surfactant;
optionally a defoaming agent;
optionally biocide; and
optionally a pH adjustor;
providing a chemical mechanical polishing pad, having a polishing surface; creating dynamic contact at an interface between the chemical mechanical polishing pad and the substrate; and dispensing the chemical mechanical polishing composition onto the polishing surface of the chemical mechanical polishing pad at or near the interface between the chemical mechanical polishing pad and the substrate; wherein some of the metal or some of the dielectric or portions of the metal and the dielectric are polished away from the substrate.

The present invention is even further directed to a chemical mechanical polishing method comprising: providing a substrate comprising a metal or a dielectric or a combination of a metal and a dielectric;

providing a chemical mechanical polishing composition comprising:
a silanized colloidal silica particle having the structure:

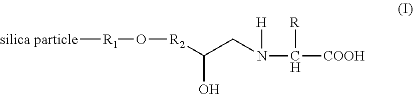

wherein R₁ and R₂ are independently chosen from linear or branched C₁-C₅ alkylene, R is a moiety selected from the group consisting of CH₃—, NH₂—C(O)—CH₂—, NH₂—C(O)—(CH₂)₂—, guanidyl, H₂N—CH₂—, ⁺H₃N—(CH₂)₄—, HO—CH₂—, HS—CH₂—, CH₃—S—(CH₂)₂—, carboxy(C₁-C₂)alkyl, benzyl and hydroxybenzyl;
water;
optionally an oxidizing agent;
optionally a complexing agent;
optionally a source of iron (III) ions;
optionally a corrosion inhibitor;
optionally a surfactant;
optionally a defoaming agent;
optionally biocide; and
optionally a pH adjustor;
providing a chemical mechanical polishing pad, having a polishing surface; creating dynamic contact at an interface between the chemical mechanical polishing pad and the substrate; and dispensing the chemical mechanical polishing composition onto the polishing surface of the chemical mechanical polishing pad at or near the interface between the chemical mechanical polishing pad and the substrate; wherein some of the metal or some of the dielectric or portions of the metal and dielectric are polished away from the substrate.

The silanized colloidal silica particles of the present invention can be used as abrasives in chemical mechanical polishing substrates containing metal features or layers and dielectric structures. The silanized colloidal silica particles of the present invention are stable at neutral to alkaline pH.

### DETAILED DESCRIPTION OF THE INVENTION

As used throughout this specification the following abbreviations have the following meanings, unless the context indicates otherwise: ° C.=degrees Centigrade; g=grams; kPa =kilopascal; Å=angstroms; DI=deionized; ppm=parts per million; m=meter; mm=millimeters; nm=nanometers; mA=milliamps; mM=millimoles; μL=micro-liters; μS=micro-siemens; min=minute; hr=hour; rpm=revolutions per minute; lbs=pounds; H=hydrogen; Cu=copper; Mn=manganese; Fe=iron; N=nitrogen; O=oxygen; W=tungsten; Ti=titanium; TiN=titanium nitride; Co=cobalt; HNO₃=nitric acid; KOH=potassium hydroxide; HO=hydroxyl; Si—OH=silanol group; GPTMS=3-glycidoxypropyltrimethoxysilane; IC=ion chromatography; wt %=percent by weight; BET=Bunauer-Emmett-Teller; RR=removal rate; Ex=example and DF=down force.

The term “chemical mechanical polishing” or “CMP” refers to a process where a substrate is polished by means of chemical and mechanical forces alone and is distinguished from electrochemical-mechanical polishing (ECMP) where an electric bias is applied to the substrate. The terms “compositions”, “dispersions” and “slurries” are used interchangeably throughout the specification. The term “silane” and “epoxysilane” are used interchangeably throughout the specification. The term “moiety” means a part of a molecule which does not have to be a functional group. The term “functionality” means a moiety of a molecule which has a decisive influence on the molecules reactivity. The term “amino acid” as used in the present specification refers to both the D and L isomers unless otherwise specified, and α- and β-amino acids unless otherwise specified. The term “TEOS” means the silicon dioxide formed from tetraethyl orthosilicate (Si(OC₂H₅)₄). The term “alkylene” means a bivalent saturated aliphatic group or moiety regarded as derived from an alkene by opening of the double bond, such as ethylene: —CH₂—CH₂—, or from an alkane by removal of two hydrogen atoms from different carbon atoms. The term “methylene group” means a methylene bridge or methanediyl group with a formula: —CH₂— where a carbon atom is bound to two hydrogen atoms and connected by single bonds to two other distinct atoms in the molecule. The term “alkyl” means an organic group with a general formula: CₙH₂₊₁ where “n” is an integer and the “yl” ending means a fragment of an alkane formed by removing a hydrogen. The term “moiety” means a part or a functional group of a molecule. The terms “a” and “an” refer to both the singular and the plural. All percentages are by weight, unless otherwise noted. All numerical ranges are inclusive and combinable in any order, except where it is logical that such numerical ranges are constrained to add up to 100%.

The present invention is directed to a silanized colloidal silica particle comprising (preferably, consisting of) a reaction product of an epoxy functionality of a silanized colloidal silica particle with a nitrogen of an amino group of an amino acid. Epoxysilane compounds react with silanol groups on the surfaces of the colloidal silica particles to form covalent siloxane bonds (Si—O—Si) with the silanol groups or, alternatively, the epoxysilane compounds are linked to the silanol groups by, for example, hydrogen bonding. In the second step, the first reaction product which includes a free epoxy functionality is reacted with an amino acid compound in an addition reaction. A hydrogen atom is removed from a nitrogen atom of an amino group of the amino acid and the nitrogen atom from the amino acid reacts with the epoxy functionality to form the final modified colloidal silica particle. Substantially all the amino acid reagents react with the epoxy functionalities to form a covalent bond.

The colloidal silanized silica particles of the present invention can be made, preferably, by making a 30-60% pre-hydrolyzed aqueous silane solution by mixing desirable amounts weight by weight of epoxysilane and DI water for about 0.5-2 hr. Silane surface modification is done by slowly adding the 30-60% pre-hydrolyzed aqueous epoxysilane solution into dispersions of colloidal silica particles over a period of about 1-10 min. DI water is then mixed with the silane modified colloidal silica particles to make dispersions. The dispersions can then be further aged at room temperature for at least 30 min.

Aqueous amino acid solutions are then added to the silane modified colloidal silica particle dispersions with mixing at room temperature. The dispersions are aged at room temperature for about 1-10 days or at 50-60 ° C. for about 1-24 hr. The dispersions are then diluted with DI water and pH is adjusted with a base, such as inorganic base chosen from potassium hydroxide or sodium hydroxide, to a pH in the range of 7 or greater.

The properties and performance of surface modified particles can depend on numbers of functional groups per surface area created by modification. Particles with different sizes or shapes have different specific surface areas, thus they require different amounts of epoxysilane and amino acid to achieve the same degree of functionalization. For this reason, degree of surface functionalization depends on both the amount of epoxysilane and amino acid added during the surface modification and total particle surface area available for surface reaction. For ease of comparison between particles with different specific surface area, the number of epoxysilane or amino acid molecules per nm² of surface area of particle is calculated from the amount of epoxysilane and amino acid added. This can be done using the following equation.

Ns=(Ws/Mw×NA)/(SSA×Wp×10¹⁸) Equation (1)

Ns: Number of epoxysilane or amino acid per nm² of surface area of particle in number of molecules/nm².
Ws: Weight of epoxysilane or amino acid added in grams.
Mw: Molecular weight, g/mol of epoxysilane or amino acid
NA: Avogadro's number, 6.022×10²³ mol⁻¹
SSA: Specific surface area of particle in m²/g
Wp: Total weight of particle in solution
SSA can be obtained by BET surface area measurement or Sears titration (determination of specific surface area of colloidal silica by titration with sodium hydroxide, G. W. Sears, Anal. Chem. 1956, 28, 12, 1981-1983.), both processes are well known in the art.

Preferably, epoxysilane compounds are mixed and reacted with the colloidal silica particles to provide a molecule of epoxysilane compound on the surface of the particle of 0.05-3 molecules of silane per nm² of surface area, more preferably, from 0.1-2.4 molecules of silane per nm² of surface area, even more preferably, from 0.6-1.2 molecules of silane per nm² of surface area.

The weight ratio of epoxysilane/silica is in the range of about 0.0005 to 0.13, more preferably, from 0.004 to 0.1, even more preferably, from 0.02 to 0.06.

Preferably, amino acids are included in amounts such that one molecule of the amino acid covers 0.05-3 molecules of amino acid per nm² of particle surface area, more preferably, from 0.1-2.4 molecules of amino acid per nm² of particle surface area. The amino acid is calculated by the same process as that of the epoxysilane.

The weight ratio of amino acid/silica is in the range of about 0.0001 to 0.1, more preferably, from 0.001 to 0.1, even more preferably, from 0.008 to 0.04. The amount of amino acid specified here is for modifying silica particles. Additional amino acids, either the same or different type can be added in the chemical mechanical polishing slurries as chemical ingredients that use such modified silica particles.

Weight in grams of the epoxysilane or amino acid can be calculated using the following equation.

Ws=(Ns×SSA×Wp×10¹⁸/NA)×Mw Equation (2)

Ns: Number of epoxysilane or amino acid per nm² of surface area of particle in number of molecules/ nm².
Ws: Weight of epoxysilane or amino acid added in grams.
Mw: Molecular weight, g/mol of epoxysilane or amino acid
NA: Avogadro's number, 6.022×10²³ mol⁻¹
SSA: Specific surface area of particle in m²/g
Wp: Total weight of particles in solution.

Epoxysilanes include, but are not limited to, 5,6-epoxyhexyltriethoxysilane, 2-(3,4-epoxycyclohexyl)ethyltrimethoxsilane, and glycidoxysilanes. Preferably, the epoxysilanes are glycidoxysilanes. Exemplary glycidoxysilane compounds are (3-glycidoxypropyl) trimethoxysilane, γ-glycidoxypropylmethyl diethoxysilane, γ-glycidoxypropyl trimethoxysilane and (3-glycidoxypropyl) hexyltrimethoxysilane.

Amino acids include, but are not limited to, glycine, alanine, serine, aspartic acid, glutamic acid, cysteine, cystine, arginine, glutamine, histidine, leucine, isoleucine, lysine, proline, methionine, phenylalanine, tyrosine, tryptophan, threonine and valine. Preferably, amino acids are selected from the group consisting of glycine, alanine, aspartic acid, glutamic acid, serine, lysine, asparagine, glutamine, methionine, phenylalanine and tyrosine. More preferably, the amino acids are selected from the group consisting of β-alanine, L-aspartic acid, L-glutamic acid and glycine.

Preferably, the reaction products of the epoxy functionality of the silanized colloidal silica particle and the amino acids of the present invention are modified silanized colloidal silica particles having the general structure:

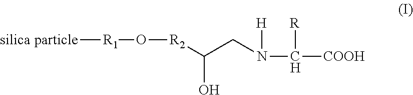

wherein R₁ and R₂ are independently chosen from linear or branched C₁-C₅ alkylene; R is a moiety selected from the group consisting of CH₃—, NH₂—C(O)—CH₂—, NH₂—C(O)—(CH₂)₂—, guanidyl, H₂N—CH₂—, ⁺H₃N—(CH₂)₄—, HO—CH₂—, HS—CH₂—, CH₃—S-(CH₂)₂—, carboxy(C₁-C₂)alkyl, benzyl and hydroxybenzyl.

Preferably, R₁ and R₂ are independently chosen from linear C₁-C₅ alkylene groups, such as —(CH₂)ₜ- where t is an integer of 1-5, more preferably, R₁ is C₃ alkylene or propylene, such as —(CH₂)ₜ- where t=3 and R₂ is C₁ alkylene or methylene, such as —(CH₂)t- where t=1. Preferably, R is a moiety selected from the group consisting of CH₃—, H₂N—CH₂—, and carboxy(C₁-C₂)alkyl.

While it is envisioned that the modified silanized colloidal silica particles of the present invention can be used in various industries, preferably, the modified silanized colloidal silica particles of the present invention are used as abrasives in chemical mechanical polishing of metals, dielectrics or substrates which include a combination of metals and dielectrics. The chemical mechanical polishing compositions of the present invention comprise a silanized colloidal silica particle comprising (preferably consisting of) a reaction product of an epoxy functionality of the silanized colloidal silica particle with a nitrogen of the amino group of an amino acid, as described above.

Preferably, the reaction product of the epoxy functionality and the amino acid has the general structure:

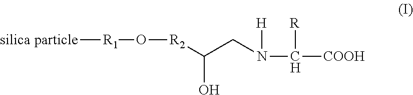

wherein R₁ and R₂ are independently chosen from linear or branched C₁-C₅ alkylene; R is a moiety selected from the group consisting of CH₃—, NH₂—C(O)—CH₂—, NH₂—C(O)—(CH₂)₂—, guanidyl, H₂N—CH₂—, ⁺H₃N—(CH₂)₄—, HO—CH₂—, HS—CH₂—, CH₃—S—(CH₂)₂—, carboxy(C₁-C₂)alkyl, benzyl and hydroxybenzyl.

Preferably, R₁ and R₂ are independently chosen from linear C₁-C₅ alkylene groups, such as —(CH₂)t- where t is an integer of 1-5, more preferably, R₁ is C₃ alkylene or propylene, such as —(CH₂)t- where t=3 and R₂ is C₁ alkylene or methylene, such as —(CH₂)t- where t=1. Preferably, R is a moiety selected from the group consisting of CH₃—, H₂N—CH₂—, and carboxy(C₁-C₂)alkyl.

The modified silanized colloidal silica abrasive particles are included in the chemical mechanical polishing compositions of the present invention in amounts of greater than 0 wt % but not more than 20 wt %, preferably, 1 wt % and greater but not more than 20 wt %, more preferably, 2 wt % but not more than 18 wt %, even more preferably, 2-15 wt %, most preferable, 2-10 wt % of the chemical mechanical polishing composition.

Preferably, the modified silanized colloidal silica particles of the present invention have an average diameter ranging from 10 nm to 100 nm, more preferably, from 20 nm to 80 nm, even more preferably, from 30 nm to 60 nm, as measured by dynamic light (DL) scattering techniques. Suitable particle size measuring instruments are available from, for example, Malvern Instruments (Malvern, UK).

Colloidal silica particles used to prepare the modified silanized colloidal silica particles of the present invention can be spherical, nodular, bent, elongated or cocoon shaped colloidal silica particles. Preferably, the surface area of the colloidal silica particles is 20 m²/g and greater, more preferably, from 20 m²/g to 200 m²/g, most preferably, from 30 m²/g to 150 m²/g. Such colloidal silica particles are commercially available. Examples of commercially available colloidal silica particles are Fuso BS-3, Fuso SH-3 and Fuso PL-2L, available from Fuso Chemical Co., LTD.

Water is also included in the chemical mechanical polishing compositions of the present invention. Preferably, the water contained in the chemical mechanical polishing compositions is at least one of deionized and distilled to limit incidental impurities.

Optionally, the chemical mechanical polishing compositions of the present invention include one or more oxidizing agents, wherein the oxidizing agents are selected from the group consisting of hydrogen peroxide (H₂O₂), monopersulfates, iodates, magnesium perphthalate, peracetic acid and other per-acids, persulfate, bromates, perbromate, persulfate, peracetic acid, periodate, nitrates, iron salts, cerium salts, Mn (III), Mn (IV) and Mn (VI) salts, silver salts, copper salts, chromium salts, cobalt salts, halogens, hypochlorites and a mixture thereof. Preferably, the oxidizing agent is selected from the group consisting of hydrogen peroxide, perchlorate, perbromate, periodate, persulfate and peracetic acid. Most preferably, the oxidizing agent is hydrogen peroxide.

The chemical mechanical polishing composition can contain 0.01-10 wt %, preferably, 0.1-5 wt %; more preferably, 1-3 wt % of an oxidizing agent.

Optionally, the chemical mechanical polishing compositions of the present invention can include one or more corrosion inhibitors. Conventional corrosion inhibitors can be used. The choice of corrosion inhibitors can depend on the metal on the substrate which is being polished. Corrosion inhibitors include, but are not limited to, adenine, benzotriazole; 1,2,3-benzotriazole; 1,6-dimethyl-1,2,3-benzotriazole; 1-(1,2-dicarboxyethyl)benzotriazole; 1-[N,N-bis(hydroxylethyl)aminomethyl]benzotrizole; or 1-(hydroxylmethyl)benzotriazole.

Corrosion inhibitors can be included in the chemical mechanical polishing composition in conventional amounts. Preferably, corrosion inhibitors are included in amounts of 0.1-1000 ppm, more preferably, from 50-500 ppm, even more preferably, from 100-450 ppm.

Optionally, the chemical mechanical polishing compositions of the present invention can include a source of iron (III) ions, wherein the source of iron (III) ions is selected from the group consisting iron (III) salts. Most preferably the chemical mechanical polishing composition contains a source of iron (III) ions, wherein the source of iron (III) ions is ferric nitrate nonahydrate, (Fe(NO₃)₃·9H₂O).

The chemical mechanical polishing composition can contain a source of iron (III) ions sufficient to introduce 1 to 200 ppm, preferably, 5 to 150 ppm, more preferably, 7.5 to 125 ppm, most preferably, 10 to 100 ppm of iron (III) ions to the chemical mechanical polishing composition. In a particularly preferred chemical mechanical polishing composition the source of iron (III) ions is included in amounts sufficient to introduce 10 to 150 ppm to the chemical mechanical polishing composition.

Optionally, the chemical mechanical polishing composition contains a pH adjusting agent. Preferably, the pH adjusting agent is selected from the group consisting of inorganic and organic pH adjusting agents. More preferably, the pH adjusting agent is selected from the group consisting of inorganic acids and inorganic bases. Inorganic acids include, but are not limited to, nitric acid, sulfuric acid, hydrochloric acid and phosphoric acid. Inorganic bases include, but are not limited to, potassium hydroxide, sodium hydroxide and ammonium hydroxide. Further preferably, the pH adjusting agent is selected from the group consisting of sodium hydroxide and potassium hydroxide. Most preferably, the pH adjusting agent is potassium hydroxide.

Sufficient amounts of the pH adjusting agent are added to the chemical mechanical polishing composition to maintain a desired pH of 7 and greater, preferably, from 7.5-12, most preferably, 7.5-8.5.

Optionally, the chemical mechanical polishing composition contains biocides, such as KORDEK™ MLX (9.5-9.9% methyl-4-isothiazolin-3-one, 89.1-89.5% water and ≤1.0% related reaction product) or KATHON™ ICP III containing active ingredients of 2-methyl isothiazolin-3-one and 5-chloro-2-methyl-4-isothiazolin-3-one, each manufactured by International Flavors & Fragrances, Inc., (KATHON and KORDEK are trademarks of International Flavors & Fragrances, Inc.).

When biocides are included in the chemical mechanical polishing composition of the present invention, the biocides are included in amounts of 0.001 wt % to 0.1 wt %, preferably, 0.001 wt % to 0.05 wt %, more preferably, 0.001 wt % to 0.01 wt %, still more preferably, 0.001 wt % to 0.005 wt %.

Optionally, the chemical mechanical polishing composition can further include surfactants. Conventional surfactants can be used in the chemical mechanical polishing compositions. Such surfactants include, but are not limited to, non-ionic surfactants, anionic surfactants, cationic surfactants, amphoteric surfactants. Mixtures of such surfactants can also be used in the chemical mechanical polishing compositions of the present invention. Minor experimentation can be used to determine the type or combination of surfactants to achieve the desired viscosity of the chemical mechanical polishing composition. Optionally, the chemical mechanical polishing compositions of the present invention can also include defoaming agents, such as non-ionic surfactants including esters, ethylene oxides, alcohols, ethoxylate, silicon compounds, fluorine compounds, ethers, glycosides and their derivatives. Anionic ether sulfates such as sodium lauryl ether sulfate (SLES) as well as the potassium and ammonium salts.

Surfactants and defoaming agents can be included in the chemical mechanical polishing compositions of the present invention in conventional amounts or in amounts tailored to provide the desired performance. For example, the chemical mechanical polishing composition can contain 0.0001 wt % to 0.1 wt %, preferably, 0.001 wt % to 0.05 wt %, more preferably, 0.01 wt % to 0.05 wt %, still more preferably, 0.01 wt % to 0.025 wt %, of a surfactant, defoaming agent or mixtures thereof.

The chemical mechanical polishing compositions can be used to polish various substrates. Preferably, the modified silanized colloidal silica abrasives of the present invention are included in chemical mechanical polishing compositions to polish Co and TEOS. However, it is envisioned that the chemical mechanical polishing compositions can be used to polish materials, such as Cu, W, Ti, TiN, Ta, TaN and other materials.

The polishing method of the present invention includes providing a chemical mechanical polishing pad, having a polishing surface; creating dynamic contact at an interface between the chemical mechanical polishing pad and the substrate; and dispensing the chemical mechanical polishing composition of the present invention onto the polishing surface of the chemical mechanical polishing pad at or near the interface between the chemical mechanical polishing pad and the substrate; wherein at least some dielectric material is polished away from the substrate.

Preferably, in the method of polishing a substrate with the chemical mechanical polishing composition of the present invention, the substrate comprises metal and a dielectric. More preferably, the substrate provided is a semiconductor substrate comprising metal and a dielectric, such as Co and TEOS or combinations thereof.

Preferably, in the method of polishing a substrate of the present invention, the chemical mechanical polishing pad provided can by any suitable polishing pad known in the art. One of ordinary skill in the art knows to select an appropriate chemical mechanical polishing pad for use in the method of the present invention. More preferably, in the method of polishing a substrate of the present invention, the chemical mechanical polishing pad provided is selected from woven and non-woven polishing pads. Still more preferably, in the method of polishing a substrate of the present invention, the chemical mechanical polishing pad provided comprises a polyurethane polishing layer. Most preferably, in the method of polishing a substrate of the present invention, the chemical mechanical polishing pad provided comprises a polyurethane polishing layer containing polymeric hollow core microparticles and a polyurethane impregnated non-woven subpad. Preferably, the chemical mechanical polishing pad provided has at least one groove on the polishing surface.

Preferably, in the method of polishing a substrate of the present invention, the chemical mechanical polishing composition provided is dispensed onto a polishing surface of the chemical mechanical polishing pad provided at or near an interface between the chemical mechanical polishing pad and the substrate.

Preferably, in the method of polishing a substrate of the present invention, dynamic contact is created at the interface between the chemical mechanical polishing pad provided and the substrate with a down force of 0.69 to 34.5 kPa normal to a surface of the substrate being polished.

Preferably, in the method of polishing a substrate of the present invention, the chemical mechanical polishing composition of the present invention has a tunable TEOS removal rate. By changing the silane, amino acid or both in the preparations of the modified colloidal silica particles the RR of the TEOS as well as the Co can be tuned. Preferably, in the method of polishing a substrate of the present invention, the chemical mechanical polishing composition has a Co removal rate of ≥800 Å/min; preferably, ≥1000 Å/min. Preferably, in the method of polishing a substrate containing Co and TEOS, Co is selectively polished over TEOS. Preferably, polishing is done with a platen speed of 90 revolutions per minute, a carrier speed of 91 revolutions per minute, a chemical mechanical polishing composition flow rate of 300 mL/min, a nominal down force of 27.6 kPa AMAT Reflexion polishing tool; and, wherein the chemical mechanical polishing pad comprises a polyurethane polishing layer containing polymeric hollow core microparticles and a polyurethane impregnated non-woven subpad.

The following examples are intended to further illustrate the present invention and are not intended to limit its scope.

### EXAMPLE 1

### Preparation of Surface Modified Colloidal Silica Particles

Aqueous amino acid solutions were prepared by mixing amino acid powder with DI water at room temperature. The type and amount of amino acids are disclosed in Table 1 below. The mixtures were neutralized with 2 wt % aqueous KOH solution. The final solids wt % in the solution was 5 wt % with pH of 12 or above.

50% pre-hydrolyzed aqueous GPTMS (3-glycidoxypropyltrimethoxysilane) solutions were prepared by mixing equal amount of the silane and DI water for 30 min at room temperature. Silane modification was done by slowly adding the 50% pre-hydrolyzed aqueous silane solutions into the particle dispersions over a period of 2-5 min. A predetermined amount of water was mixed with the colloidal silica particles to make the particle concentration 15% by weight after surface modification with GPTMS. The mixture was then further aged at room temperature for 30 min to 1 hr before adding the neutralized amino acid solutions.

The neutralized amino acid solutions were added into the above prepared particle dispersion with mixing. The mixtures were then further heated in a 55° C. oven for 20 hrs to obtain the final modified colloidal silica particles.

TABLE 1

| | GPTMS/ | GPTMS | Amino Acid | Amino | Amino Acid |
|---|---|---|---|---|---|
| Example | nm² | (wt %) | on Particle | Acid/nm² | (wt %) |
| Ex-1-1 | 0.6 | 0.385 | β-Alanine | 0.6 | 0.145 |
| Ex-1-2 | 0.6 | 0.385 | L-Aspartic | 0.6 | 0.217 |
| | | | Acid | | |
| Ex1-3 | 1.2 | 0.771 | Glycine | 1.2 | 0.245 |
| Ex1-4 | 1.2 | 0.771 | β-Alanine | 1.2 | 0.291 |
| Ex1-5 | 1.2 | 0.771 | L-Aspartic | 1.2 | 0.434 |
| | | | Acid | | |
| Ex1-6 | 1.2 | 0.771 | L-Glutamic | 1.2 | 0.480 |
| | | | Acid | | |

All the compositions of the examples in Tablel contained 15% by weight of Fuso PL-2L colloidal silica particles as provided by FUSO Chemical Co., Ltd. The unit of the amount of silane and amino acid listed in the table is number of molecules per nm² based on surface area of Fuso PL-2L colloidal silica particles which was 109 m²/g.

The molecules per nm² for the silane and amino acids were determined using the following equation:

Ns=(Ws/Mw×NA)/(SSA×Wp×10¹⁸)

Ns: Number of GPTMS or amino acid per nm² surface area of particle in number of molecules/nm²,
NA: Avogadro's number, 6.022×10²³ mol⁻¹,
Mw of GPTMS=236.34 g/mol,
Mw of β-Alanine=89.09 g/mol,
Mw of L-Aspartic acid=133.11 g/mol,
Mw of L-Glutamic acid=147.13 g/mol,
Mw of Glycine=75.07 g/mol,
SSA=109 m²/g,
Wp=15 wt%,
Ws=as shown in Table 1 (convertible to g/L)

### EXAMPLE 2

### Conductivity and Stability of Chemical Mechanical Polishing Compositions

Modified colloidal silica particles were prepared according to the method described in Example 1 above, except Comparative Example Ex2A included unmodified Fuso PL-2L particles.

TABLE 2

| | | | Amino | Amino | Amino | Aspartic |
|---|---|---|---|---|---|---|
| | GPTMS/ | GPTMS | Acid on | Acid/ | Acid | Acid |
| Example | nm² | (wt %) | Particle | nm² | (wt %) | (wt %) |
| Compar- | 0 | 0 | 0 | 0 | 0 | 1 |
| ative | | | | | | |
| Ex2A | | | | | | |
| Compar- | 0.6 | 0.1503 | 0 | 0 | 0 | 1 |
| ative | | | | | | |
| Ex2B | | | | | | |
| Ex2-1 | 0.6 | 0.153 | β- | 0.6 | 0.057 | 0.958 |
| | | | Alanine | | | |
| Ex2-2 | 0.6 | 0.153 | L- | 0.6 | 0.085 | 0.915 |
| | | | Aspartic | | | |
| | | | Acid | | | |
| Compar- | 1.2 | 0.3006 | 0 | 0 | 0 | 1 |
| ative | | | | | | |
| Ex2C | | | | | | |
| Ex2-3 | 1.2 | 0.3006 | Glycine | 1.2 | 0.095 | 0.915 |
| Ex2-4 | 1.2 | 0.3006 | β- | 1.2 | 0.113 | 0.915 |
| | | | Alanine | | | |
| Ex2-5 | 1.2 | 0.3006 | L- | 1.2 | 0.169 | 0.831 |
| | | | Aspartic | | | |
| | | | Acid | | | |
| Ex2-6 | 1.2 | 0.3006 | L- | 1.2 | 0.187 | 0.831 |
| | | | Glutamic | | | |
| | | | Acid | | | |

All the examples in Table 2 contained 5.85% by weight of Fuso PL-2L particles. Slurries were formulated in such a way that total [—COOH] concentration (sum of attached on particle+free) was the same (150.3 mM) for each slurry such that each composition in table 2 has similar conductivity and ionic strength. The unit of the amount of silane and amine listed in the table is number of molecules per nm² based on surface area of Fuso PL-2L silica particle being 109 m²/g.

CMP slurry compositions were prepared by mixing the silica particle dispersions, DI water, aspartic acid, 0.1 wt % adenine and 0.02 wt % KORDEK™ MLX Biocide at room temperature. The pH of the slurries was adjusted with 2 wt % aqueous KOH solution to target pH value of about 8.

The slurries were aged in an oven at 55° C. for 4 weeks to accelerate their aging characteristics for estimating slurry shelf life storage at room temperature. As seen from Table 3, the slurries which contained GPTMS modified colloidal silica particles or the GPTMS and amino acid modified colloidal silica particles remained dispersed with mean particle sizes determined by CPS Disc Centrifuge (CPS Instruments, Inc., Prairieville, La.) well below 100 nm after 28 days aging at high temperature. The slurries which contained GPTMS and amino acid modified colloidal silica particles had further improved stability compared to the slurries which contained the corresponding amount of GPTMS modified colloidal silica particles. As shown in Table 2 and Table 3, Comparative Ex2B contained 0.6 GPTMS/nm². However, Ex2-1 and Ex2-2 which contained silica particles that were modified with both GPTMS and amino acid, had significantly smaller particles at Day 28 than the particle sizes of comparative Ex2B. The same effect was also observed in slurries Ex2-3 to Ex2-6 which included 1.2 molecules GPTMS/nm² and 1.2 molecules amino acid/nm² modified colloidal silica particles. These slurries had smaller mean particles sizes at Day 28 than Comparative Ex2C slurry which included 1.2 molecules GPTMS/nm² modified colloidal silica particles. The slurry containing unmodified colloidal silica PL-2L particles gelled after 28 days aging at high temperature.

Particle conductivity (Measured by YSI model 3200, probe YSI 3235) was substantially the same for GPTMS modified colloidal silica and the GPTMS and amino acid modified colloidal silica containing slurries. Nevertheless, the slurries of the present invention had good conductivity even after 28 days.

TABLE 3

| | | | | | Day 0 | Day 28 |
|---|---|---|---|---|---|---|
| | | | Day 0 | Day 28 | Mean | Mean |
| | | | Conduc- | Conduc- | Particle | Particle |
| | Day 0 | Day 28 | tivity | tivity | Size | Size |
| Example | pH | pH | (μS) | (μS) | (nm) | (nm) |
| Compar- | 7.67 | Gelled | 6787 | gelled | 36 | Gelled |
| ative | | | | | | |
| Ex2A | | | | | | |
| Compar- | 7.66 | 7.69 | 6705 | 6726 | 38 | 70 |
| ative | | | | | | |
| Ex2B | | | | | | |
| Ex2-1 | 7.79 | 7.83 | 6526 | 6544 | 37 | 50 |
| Ex2-2 | 7.78 | 7.83 | 6738 | 6771 | 36 | 51 |
| Compar- | 7.67 | 7.70 | 6624 | 6642 | 36 | 55 |
| ative | | | | | | |
| Ex2C | | | | | | |
| Ex2-3 | 7.82 | 7.88 | 6224 | 6334 | 34 | 37 |
| Ex2-4 | 7.88 | 7.96 | 6188 | 6234 | 34 | 35 |
| Ex2-5 | 7.92 | 8.05 | 6729 | 6797 | 34 | 36 |
| Ex2-6 | 7.86 | 8.01 | 6702 | 6765 | 33 | 35 |

### EXAMPLE 3

### Chemical Mechanical Polishing of Cobalt and TEOS

Modified colloidal silica particles were prepared as described in Example 1 above.

TABLE 4

| | GPTMS/ | Amino Acid | Amino | Aspartic Acid |
|---|---|---|---|---|
| Example | nm² | on Particle | Acid/nm² | (wt %) |
| Comparative | 0 | 0 | 0 | 0.5 |
| Ex3A | | | | |
| Comparative | 0.6 | 0 | 0 | 0.5 |
| Ex3B | | | | |
| Ex3-1 | 0.6 | β-Alanine | 0.6 | 0.479 |
| Ex3-2 | 0.6 | L-Aspartic | 0.6 | 0.458 |
| | | Acid | | |
| Comparative | 1.2 | 0 | 0 | 0.5 |
| Ex3C | | | | |
| Ex3-3 | 1.2 | Glycine | 1.2 | 0.458 |
| Ex3-4 | 1.2 | β-Alanine | 1.2 | 0.458 |
| Ex3-5 | 1.2 | L-Aspartic | 1.2 | 0.415 |
| | | Acid | | |
| Ex3-6 | 1.2 | L-Glutamic | 1.2 | 0.415 |
| | | Acid | | |

Slurries were prepared substantially according to the method as in Example 2 and diluted with DI water at slurry:DI water weight ratio 1:1. The modified and unmodified colloidal silica particle concentrations were 2.925 wt %, adenine was at a concentration of 0.05 wt %, H₂O₂ was added to the slurries at a concentration of 0.3 wt % and KORDEK™ MLX Biocide was at a concentration of 0.01 wt %. Aspartic acid was added to the slurries as a chelating or complexing agent and to maintain a pH from 7.5 to 8.1. The slurries were formulated in such a way that total [—COOH] concentration (sum of attached on particle+free) was the same (75.1 mM) for each slurry.

### CMP Polishing Conditions:

Polishing tool: AMAT Reflexion

### Slurry: Various Slurries

Pad: Visionpad™ 6000 pad (1010 groove)

### Conditioner: Saesol AK45

Break-in: 7.5 lb for 20 mins+5 lb for 10 mins
Conditioning: Full in-situ at 5 lb DF
Polish process: 6.89 kPa, 90/91 rpm, 300 mL/min
Polishing details:
PVD Co (DKNano), TEOS (Pure Wafer) wafers
20 s Co polish, 60 s TEOS polish
Dummy: 15 TEOS dummies after pad break-in, then rate wafers, 4 TEOS dummies between slurries.

TABLE 5

| | Co RR | TEOS RR | Co/TEOS |
|---|---|---|---|
| Example | (Å/min) | (Å/min) | Selectivity |
| Comparative Ex3A | 1523 | 40 | 38.1 |
| Comparative Ex3B | 1315 | 34 | 38.3 |
| Ex3-1 | 1402 | 33 | 42.5 |
| Ex3-2 | 1354 | 35 | 39.0 |
| Comparative Ex3C | 1232 | 31 | 39.4 |
| Ex3-3 | 1305 | 24 | 55.0 |
| Ex3-4 | 1322 | 24 | 54.2 |
| Ex3-5 | 1387 | 26 | 53.8 |
| Ex3-6 | 1286 | 26 | 49.8 |

The polishing results showed that the chemical mechanical polishing compositions which included the modified colloidal silica particles of the present invention overall had higher Co:TEOS selectivity ratios than the comparatives.

What is claimed is:

1. A silanized colloidal silica particle comprising a reaction product of an epoxy functionality of the silanized colloidal silica particle with a nitrogen of an amino group of an amino acid.

2. The silanized colloidal silica particle of claim 1, wherein the amino acid is selected from the group consisting of glycine, alanine, serine, aspartic acid, glutamic acid, cysteine, cystine, arginine, glutamine, histidine, leucine, isoleucine, lysine, proline, methionine, phenylalanine, tyrosine, tryptophan, threonine and valine.

3. The silanized colloidal silica particle of claim 1, wherein the silanized colloidal silica particle has the structure: 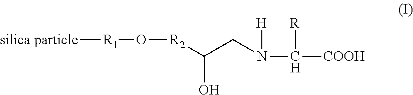
wherein R₁ and R₂ are independently chosen from linear or branched C₁-C₅ alkylene, and R is a moiety selected from the group consisting of CH₃—, NH₂—C(O)—CH₂—, NH₂—C(O)—(CH₂)₂—, guanidyl, H₂N—CH₂—, ⁺H₃N—(CH₂)₄—, HO—CH₂—, HS—CH₂—, CH₃—S—(CH₂)₂—, carboxy(C₁-C₂)alkyl, benzyl and hydroxybenzyl.

4. A chemical mechanical polishing composition comprising a silanized colloidal silica particle comprising a reaction product of an epoxy functionality of the silanized colloidal silica particle with a nitrogen of an amino group of an amino acid;
water;
optionally an oxidizing agent;
optionally a complexing agent;
optionally a source of iron (III) ions;
optionally a corrosion inhibitor;
optionally a surfactant;
optionally a defoaming agent;
optionally biocide; and
optionally a pH adjustor.

5. The chemical mechanical polishing compositions of claim 4, wherein the silanized colloidal silica particle has the structure: 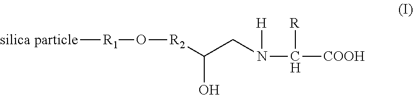
wherein R₁ and R₂ are independently chosen from linear or branched C₁-C₅ alkylene, and R is a moiety selected from the group consisting of CH₃—, NH₂—C(O)—CH₂—, NH₂—C(O)—(CH₂)₂—, guanidyl, H₂N—CH₂—, ⁺H₃N—(CH₂)₄—, HO—CH₂—, HS—CH₂—, CH₃—S—(CH₂)₂—, carboxy(C₁-C₂)alkyl, benzyl and hydroxybenzyl.

6. A chemical mechanical polishing method comprising: providing a substrate comprising a metal and a dielectric;
providing a chemical mechanical polishing composition comprising a silanized colloidal silica particle, wherein the silanized colloidal silica particle comprises a reaction product of an epoxy functionality of the silanized colloidal silica particle with a nitrogen of an amino group of an amino acid;
water;
optionally an oxidizing agent;
optionally a complexing agent;
optionally a source of iron (III) ions;
optionally a corrosion inhibitor;
optionally a surfactant;
optionally a defoaming agent;
optionally biocide; and
optionally a pH adjustor;
providing a chemical mechanical polishing pad, having a polishing surface; creating dynamic contact at an interface between the chemical mechanical polishing pad and the substrate; and dispensing the chemical mechanical polishing composition onto the polishing surface of the chemical mechanical polishing pad at or near the interface between the chemical mechanical polishing pad and the substrate; wherein some of the metal or some of the dielectric or portions of the metal and dielectric are polished away from the substrate.

7. The chemical mechanical polishing method of claim 6, wherein the silanized colloidal silica particle has the structure: 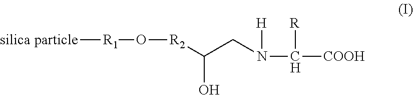
wherein R₁ and R₂ are independently chosen from linear or branched C₁-C₅ alkylene; R is a moiety selected from the group consisting of CH₃—, NH₂—C(O)—CH₂—, NH₂—C(O)—(CH₂)₂—, guanidyl, H₂N—CH₂—, ⁺H₃N—(CH₂)₄—, HO—CH₂—, HS—CH₂—, CH₃—S—(CH₂)₂—, carboxy(C₁-C₂)alkyl, benzyl and hydroxybenzyl.
